(19) United States
(12) Patent Application Publication
(10) Pub. No.: US 2021/0382217 A1
(43) Pub. Date: Dec. 9, 2021

(54) ILLUMINATION DEVICE, IN PARTICULAR AN ILLUMINATION DEVICE FOR A MOTOR VEHICLE

(71) Applicant: HELLA GmbH & Co. KGaA, Lippstadt (DE)

(72) Inventors: Marcus GIEHL, Jena (DE); Daniela KARTHAUS, Lippstadt (DE); Martin MUEGGE, Geseke (DE); Mathias NIEDLING, Lippstadt (DE)

(73) Assignee: HELLA GmbH & Co. KGaA, Lippstadt (DE)

(21) Appl. No.: 17/342,218

(22) Filed: Jun. 8, 2021

(30) Foreign Application Priority Data
Jun. 8, 2020 (DE) 10 2020 115 115.2

(51) Int. Cl. G02B 5/32; F21S 41/141; F21S 41/16

(52) U.S. Cl. CPC G02B 5/32; F21Y 2115/10; F21S 41/16; F21S 41/141

(57) ABSTRACT

An illumination device, in particular an illumination device for a motor vehicle, comprising a light source for generating light which has components in a blue, green, and red wavelength range, and a holographic optic which the light emitted by the light source strikes, wherein the light striking the holographic optics is used at least partially for reconstructing a hologram, wherein the light emerges from the illumination device after interaction with the holographic optic, and wherein the light source is designed so that the spectral distribution of the light emitted by the light source is adapted to the spectral diffraction efficiency of the holographic optics.

This nonprovisional application claims priority under 35 U.S.C. § 119(a) to German Patent Application No. 10 2020 115 115.2, which was filed in Germany on Jun. 8, 2020 and which is herein incorporated by reference.

### BACKGROUND OF THE INVENTION

### Field of the Invention

The present invention relates to an illumination device, in particular an illumination device for a motor vehicle.

### Description of the Background Art

An illumination device of the aforementioned type is known, for example, from DE 10 2006 043 402 A1, which corresponds to U.S. Pat. No. 7,645,054. The illumination device described therein is designed, for example, as a headlight of a motor vehicle and comprises a light source for generating white light. For this purpose, it is provided either to convert the light of a light-emitting diode (LED) into white light with a converter or to combine multiple light-emitting diodes to form an RGB light source. The illumination device further comprises a holographic optic, which the white light strikes for reconstructing the hologram of the holographic optic. The holographic optic bends the light in order to achieve a predetermined light distribution.

Due to the wavelength selectivity of, for example, volume holograms, only certain spectral components of the light source are used for reconstructing the hologram when illuminating the holographic optic. In lighting applications in particular, this can have the consequence that the spectrum of a white light source is not completely available behind the hologram and the color value of the light source or the white light overlapping is shifted. Light sources that appear white in front of the hologram can thus produce, for example, a yellowish color impression behind the hologram.

For example, for headlights of motor vehicles according to ECE regulation 123, it is necessary that the color point of the spectrum of the emitted beam lies in the defined, permissible ECE white area (also see: Deutsches Institut für Normung e.V. [German Institute for Standardization e.V.] DIN 5033-2, Part 2: Standard Colorimetric Systems, May 1992). Current automotive white light sources are therefore optimized so that their spectra lie within the ECE white area. This case is optimal with conventional optics that use all spectral components. However, if wavelength-selective optics, such as, for example, holographic optics, are used, thus the color point of the spectrum of the light emerging from the illumination device are perhaps not within the permissible ECE white area.

FIG. 3 shows the spectral distribution 1 of the light emitted by a common white light light-emitting diode (see the dashed line) and, by way of example, the spectral diffraction efficiency 2 of a holographic optic, in which, for example, three reflection holograms with three different wavelengths were written (see the solid line). It becomes apparent that the spectral diffraction efficiency 2 has three sharp peaks 3, 4, 5 in the blue, green, and red spectral range. The dotted line illustrates the spectral distribution 6 of a laser beam used for writing the hologram for the green spectral range.

The white light light-emitting diode uses a blue light-emitting diode which results in a local peak 7 of spectral distribution 1 in the blue range. The white light light-emitting diode further has a converter which partially converts the blue light and results in the broad peak 8 of spectral distribution 1 in the orange region. The light-emitting diode spectral components lying within the ranges of spectral diffraction efficiency 2 which enable an effective diffraction are selected from the hologram. These are essentially the spectral components in the region of the sharp peaks 3, 4, 5. As a result, large parts of the luminous flux of the light-emitting diode are lost and there may be a shift in the color point of the white light overlapping behind the holographic optic. This can be seen from FIG. 3 in particular for the relationship of the green and red components of the light, because spectral distribution 1 of the white light light-emitting diode in the region of peak 4 located in the green spectral range has a significantly greater intensity than in the region of peak 5 located in the red spectral range. The green spectral components are thus diffracted more efficiently than the red spectral components, so that there is a shift in the color point.

### SUMMARY OF THE INVENTION

It is therefore an object of the present invention to provide an improved illumination device.

According to an exemplary embodiment, it is provided that the light source is designed so that the spectral distribution of the light emitted by the light source is adapted to the spectral diffraction efficiency of the holographic optic. It can be ensured in this way, on the one hand, that the color point of the spectrum of the light emerging from the illumination device lies in the ECE white area. On the other hand, a higher efficiency can be achieved because more spectral components of the light emitted by the light source can be used. In addition, an impression of whiteness can be generated behind the holographic optic without having to make additional adjustments to the hologram or to use color filters.

It can be provided that the light source comprises at least one light-emitting diode or at least one laser diode as well as a converter which at least partially changes the spectral distribution of the light emitted by the light source when the illumination device is in operation, and/or that the light source is designed as an RGB light source and comprises a plurality of light-emitting diodes or a plurality of laser diodes of different wavelengths. Both types of light sources enable the adaptation of the light generated by the light source to the spectral diffraction efficiency of the holographic optic.

There is the possibility that the illumination device is designed so that the color point of the spectrum of the light emitted by the light source does not lie in the ECE white area before the interaction with the holographic optic. For example, a targeted shift of the color point of the spectrum of the light, emitted by the light source, out of the ECE white area can prove to be useful in order to achieve an optimal adaptation of the light to the spectral diffraction efficiency of the holographic optic.

It can be provided that the hologram was written in the holographic optic with three different types of laser light which had wavelengths different from one another, in particular with blue, green, and red laser light, for example, with blue laser light with a wavelength of about 450 nm, with green laser light with a wavelength of about 534 nm, and with red laser light with a wavelength of about 638 nm. Accordingly, the spectral diffraction efficiency of the holographic optic can have local peaks in three spaced-apart wavelength ranges, in particular wherein an effective diffraction of the light striking the holographic optic takes place in a range of about ±15 nm around these local peaks. In this regard, the local peaks of the spectral diffraction efficiency of the holographic optic can preferably be located in a blue, green, and red wavelength range, for example, at about 450 nm, at about 534 nm, and at about 638 nm.

There is the possibility that the spectral distribution of the light emitted by the light source has a local peak in a blue and/or in a green and/or a red spectral range. The spectral distribution can thus have a shape similar to the spectral diffraction efficiency of the holographic optic, so that an adaptation of the light, emitted by the light source, to the diffraction efficiency of the holographic optic is facilitated.

It can be provided in this regard that the local peak of the spectral distribution of the light emitted by the light source, said peak located in the blue spectral range, has such a half width that the local peak of the spectral diffraction efficiency of the holographic optics, said peak located in the blue wavelength range, is within this half width, in particular wherein the intensity of the light emitted by the light source at the wavelength of the local peak of the spectral diffraction efficiency of the holographic optic, said peak located in the blue wavelength range, is more than 60%, preferably more than 80% of the intensity of the local peak of the spectral distribution of the light emitted by the light source, said peak located in the blue spectral range. The spectral component formed by the local peak in the blue spectral range of the light distribution can thus contribute relatively effectively to the diffraction by the holographic optic.

In this case, it can be provided further that the local peak of the spectral distribution of the light emitted by the light source, said peak located in the green spectral range, has such a half width that the local peak of the spectral diffraction efficiency of the holographic optic, said peak located in the green wavelength range, is within this half width, in particular wherein the intensity of the light emitted by the light source at the wavelength of the local peak of the spectral diffraction efficiency of the holographic optic, said peak located in the green wavelength range, is more than 60%, preferably more than 80% of the intensity of the local peak of the spectral distribution of the light emitted by the light source, said peak located in the green spectral range. The spectral component formed by the local peak in the green spectral range of the light distribution can thus also contribute relatively effectively to the diffraction by the holographic optic.

It can be provided in this regard further that the local peak of the spectral distribution of the light emitted by the light source, said peak located in the red spectral range, has such a half width that the local peak of the spectral diffraction efficiency of the holographic optic, said peak located in the red wavelength range, is within this half width, in particular wherein the intensity of the light emitted by the light source at the wavelength of the local peak of the spectral diffraction efficiency of the holographic optic, said peak located in the red wavelength range, is more than 60%, preferably more than 80% of the intensity of the local peak of the spectral distribution of the light emitted by the light source, said peak located in the red spectral range. The spectral component formed by the local peak in the red spectral range of the light distribution can also thus contribute relatively effectively to the diffraction by the holographic optic.

There is the possibility that the intensity of the light emitted by the light source in a red spectral range is more than 50%, in particular more than 75%, preferably more than 85% of the intensity of the light in a green spectral range. It can be provided thereby that the intensity of the light emitted by the light source at the wavelength of the local peak of the spectral diffraction efficiency of the holographic optic, said peak located in the red wavelength range, is more than 50%, in particular more than 75%, preferably more than 85% of the intensity of the light at the wavelength of the local peak of the spectral diffraction efficiency of the holographic optic, said peak located in the green wavelength range. As a result, the red spectral components are diffracted as efficiently as the green spectral components of the light emitted by the light source.

There is also the possibility further that the intensity of the light emitted by the light source in a red spectral range is more than 40%, in particular more than 50% of the intensity of the light in a blue spectral range. It can be provided thereby that the intensity of the light emitted by the light source at the wavelength of the local peak of the spectral diffraction efficiency of the holographic optic, said peak located in the red wavelength range, is more than 40%, in particular more than 50% of the intensity of the light at the wavelength of the local peak of the spectral diffraction efficiency of the holographic optic, said peak located in the blue wavelength range. In this way, in comparison to the blue spectral components of the light emitted by the light source, the red spectral components are at least not as inefficiently diffracted as in the prior art shown in FIG. 3.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a diagram in which the spectral distribution of the light emitted by a light source of a first embodiment of an illumination device of the invention, the spectral diffraction efficiency of a holographic optic, and the spectral distribution of a laser beam used to write the hologram of the holographic optic are illustrated, wherein the distributions and the diffraction efficiency are plotted in arbitrary units against the wavelength in nm;

FIG. 2 shows a diagram in which the spectral distribution of the light emitted by a light source of a second embodiment of an illumination device of the invention, the spectral diffraction efficiency of a holographic optic, and the spectral distribution of a laser beam used to write the hologram of the holographic optic are illustrated, wherein the distributions and the diffraction efficiency are plotted in arbitrary units against the wavelength in nm;

FIG. 3 shows a diagram in which the spectral distribution of the light emitted by a common white light light-emitting diode, the spectral diffraction efficiency of a holographic optic, and the spectral distribution of a laser beam used to write the hologram of the holographic optic are illustrated, wherein the distributions and the diffraction efficiency are plotted in arbitrary units against the wavelength in nm.

### DETAILED DESCRIPTION

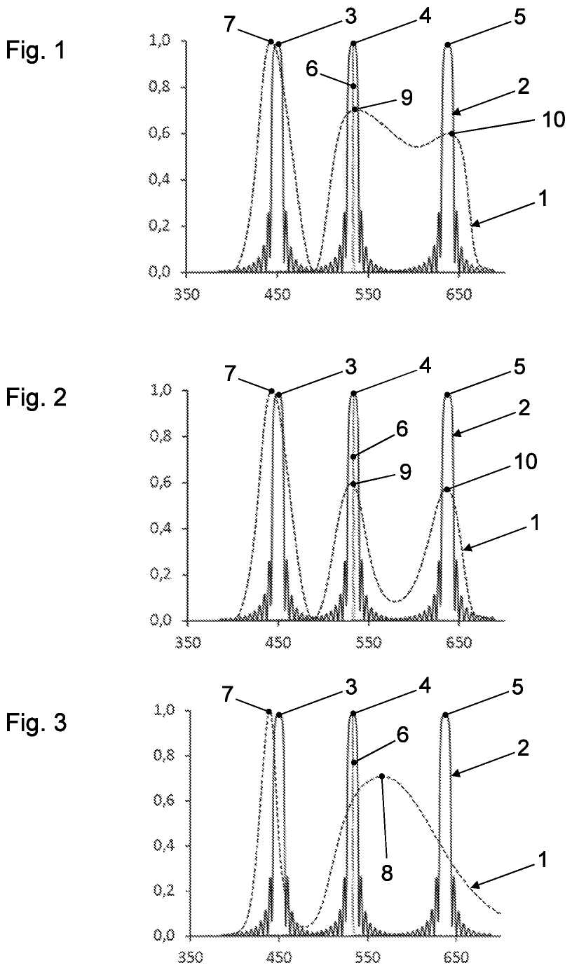

FIG. 1 shows the spectral distribution 1 of the light emitted by a light source of a first embodiment of an illumination device of the invention. The light source can be, for example, a blue light-emitting diode with a suitable converter. Because of the blue light-emitting diode, distribution 1 has a local peak 7 in the blue spectral range. In contrast to the white light light-emitting diode shown in FIG. 3, the wavelength of the blue light-emitting diode and the converter material are selected so that spectral distribution 1 is better adapted to spectral diffraction efficiency 2 of the holographic optic.

The holographic optic can comprise, for example, a film or a stack of films in which one or each hologram is written. The hologram can be a reflection hologram or a transmission hologram or an edge-lit hologram.

It becomes apparent that spectral distribution 1 of the light emitted by the light source has, in addition to the local peak 7 in the blue region, distinct local peaks 9, 10 in the green and red regions. Local peak 7 overlaps more strongly with local peak 3 of spectral diffraction efficiency 2 than in the case of the white light light-emitting diode shown in FIG. 3. Furthermore, local peaks 9, 10 are located substantially in the region of the green and red wavelengths of local peaks 4, 5 of spectral diffraction efficiency 2, so that an effective diffraction of the light, emitted by the light source, takes place in these regions as well.

FIG. 2 shows spectral distribution 1 of the light emitted by a light source of a second embodiment of an illumination device of the invention. The light source can be, for example, a blue light-emitting diode with a converter different from the embodiment according to FIG. 1. The light source can, however, also be an RGB light source or a combination of an RGB light source with a converter.

It becomes apparent that in this exemplary embodiment, spectral distribution 1 of the light emitted by the light source has, in addition to the local peak 7 in the blue region, more distinct local peaks 9, 10 in the green and red regions. Local peak 7 overlaps similarly strongly with local peak 3 of spectral diffraction efficiency 2 as in the embodiment according to FIG. 1. However, local peaks 9, 10 in the embodiment according to FIG. 2 are relatively narrow and are located almost exclusively in the region of the green and red wavelengths of local peaks 4, 5 of spectral diffraction efficiency 2.

As a result, in the embodiment according to FIG. 2, an even higher efficiency can be achieved because almost all of the spectral components of the light emitted by the light source can be used for diffraction on the hologram.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An illumination device for a motor vehicle, the illumnination device comprising:
a light source for generating light which has components in a blue, green, and red wavelength range; and
a holographic optic which the light emitted by the light source strikes, wherein the light striking the holographic optic is used at least partially for reconstructing a hologram, and wherein the light emerges from the illumination device after interaction with the holographic optic,
wherein the light source is configured so that the spectral distribution of the light emitted by the light source is adapted to the spectral diffraction efficiency of the holographic optic.

2. The illumination device according to claim 1, wherein the light source comprises at least one light-emitting diode or at least one laser diode as well as a converter which at least partially changes the spectral distribution of the light emitted by the light source when the illumination device is in operation, and/or in wherein the light source is designed as an RGB light source and comprises a plurality of light-emitting diodes or a plurality of laser diodes of different wavelengths.

3. The illumination device according to claim 1, wherein the illumination device is designed so that the color point of the spectrum of the light emerging from the illumination device lies in the ECE white area.

4. The illumination device according to claim 1, wherein the illumination device is designed so that the color point of the spectrum of the light emitted by the light source does not lie in the ECE white area before the interaction with the holographic optic.

5. The illumination device according to claim 1, wherein the hologram was written in the holographic optic with three different types of laser light which had wavelengths different from one another, in particular with blue, green, and red laser light, for example, with blue laser light with a wavelength of about 450 nm, with green laser light with a wavelength of about 534 nm, and with red laser light with a wavelength of about 638 nm.

6. The illumination device according to claim 1, wherein the spectral diffraction efficiency of the holographic optic has local peaks in three spaced-apart wavelength ranges, or wherein an effective diffraction of the light striking the holographic optic takes place in a range of about ±15 nm around the local peaks.

7. The illumination device according to claim 6, wherein the local peaks of the diffraction efficiency of the holographic optic are located in a blue, green, and red wavelength range, in particular at about 450 nm, at about 534 nm, and at about 638 nm.

8. The illumination device according to claim 1, wherein the spectral distribution of the light emitted by the light source has a local peak in a blue and/or in a green and/or a red spectral range.

9. The illumination device according to claim 8, wherein the local peak of the spectral distribution of the light emitted by the light source, the peak located in the blue spectral range, has such a half width that the local peak of the spectral diffraction efficiency of the holographic optic, the peak located in the blue wavelength range, is within this half width, in particular wherein the intensity of the light emitted by the light source at the wavelength of the local peak of the spectral diffraction efficiency of the holographic optic, the peak located in the blue wavelength range, is more than 60%, preferably more than 80% of the intensity of the local peak of the spectral distribution of the light emitted by the light source, said peak located in the blue spectral range.

10. The illumination device according to claim 8, wherein the local peak of the spectral distribution of the light emitted by the light source, said peak located in the green spectral range, has such a half width that the local peak of the spectral diffraction efficiency of the holographic optic, said peak located in the green wavelength range, is within this half width, in particular wherein the intensity of the light emitted by the light source at the wavelength of the local peak of the spectral diffraction efficiency of the holographic optic, said peak located in the green wavelength range, is more than 60%, preferably more than 80% of the intensity of the local peak of the spectral distribution of the light emitted by the light source, said peak located in the green spectral range.

11. The illumination device according to claim 8, wherein the local peak of the spectral distribution of the light emitted by the light source, said peak located in the red spectral range, has such a half width that the local peak of the spectral diffraction efficiency of the holographic optic, said peak located in the red wavelength range, is within this half width, in particular wherein the intensity of the light emitted by the light source at the wavelength of the local peak of the spectral diffraction efficiency of the holographic optic, said peak located in the red wavelength range, is more than 60%, preferably more than 80% of the intensity of the local peak of the spectral distribution of the light emitted by the light source, said peak located in the red spectral range.

12. The illumination device according to claim 1, wherein an intensity of the light emitted by the light source in a red spectral range is more than 50%, in particular more than 75%, preferably more than 85% of the intensity of the light in a green spectral range.

13. The illumination device according to claim 12, wherein the intensity of the light emitted by the light source at the wavelength of the local peak of the spectral diffraction efficiency of the holographic optic, said peak located in the red wavelength range, is more than 50%, in particular more than 75%, preferably more than 85% of the intensity of the light at the wavelength of the local peak of the spectral diffraction efficiency of the holographic optic, said peak located in the green wavelength range.

14. The illumination device according to claim 1, wherein an intensity of the light emitted by the light source in a red spectral range is more than 40%, in particular more than 50% of the intensity of the light in a blue spectral range.

15. The illumination device according to claim 14, wherein the intensity of the light emitted by the light source at the wavelength of the local peak of the spectral diffraction efficiency of the holographic optic, said peak located in the red wavelength range, is more than 40%, in particular more than 50% of the intensity of the light at the wavelength of the local peak of the spectral diffraction efficiency of the holographic optic, said peak located in the blue wavelength range.
